(19) United States
(12) Patent Application Publication
(10) Pub. No.: US 2026/0287612 A1
(43) Pub. Date: Sep. 24, 2026

(54) MULTI-HEAD AFM FOR DEFECT INSPECTION AND REVIEW

(71) Applicant: Nearfield Instruments B.V., Rotterdam (NL)

(72) Inventors: Artem KHACHATURIANTS, Rotterdam (NL); Cornel BOZDOG, Boise, ID (US); Seokhan KIM, Rotterdam (NL)

(21) Appl. No.: 19/474,198

(22) PCT Filed: Apr. 12, 2024
(86) PCT No.: PCT/NL2024/050192

§ 371 Date: Oct. 10, 2025

(30) Foreign Application Priority Data
Apr. 14, 2023 (NL) 2034580

(51) Int. Cl. G01Q 70/06; G01Q 10/06; G01Q 60/38

(52) U.S. Cl. CPC G01Q 70/06; G01Q 10/06; G01Q 60/38

(57) ABSTRACT

Method of inspecting and reviewing defects in substrates using a scanning probe microscope comprising multiple scanning heads and a substrate carrier, wherein each of the multiple scanning heads comprises a probe including a probe tip arranged for scanning of a substrate surface, wherein the method comprises:—providing the substrate on the substrate carrier, wherein the substrate carrier is arranged to position the substrate relative to at least one of the multiple scanning heads;—scanning of the substrate surface in a first scanning mode using at least one first scanning head of the multiple scanning heads;—scanning of the substrate surface in a second scanning mode using at least one second scanning head of the multiple scanning heads, wherein the at least one first scanning head and the at least one second scanning head are different scanning heads of the multiple scanning heads;—wherein the first scanning mode has a lower scanning resolution than the second scanning mode.

The invention relates to a method of inspecting and reviewing defects and a scanning probe microscope for inspecting and reviewing defects.

Scanning probe microscopy is a widespread class of microscopy methods that is based upon the scanning of a surface by means a probe tip in continuous or periodic, i.e. intermittent, contact with the surface. The method enables the detection and mapping of surface features—e.g. trenches, dimples, edges, roughness, etcetera—on the surface of a sample and below the surface of a sample with great accuracy and at high resolution. Measurements below the surface are performed using ultrasound in combination with scanning the surface using a probe. The high resolution enables the detection of even nanometer sized structures, and as a result of this high resolution has become very popular for example as a tool in the production of semiconductor elements. However, scanning probe microscopy is used in many other applications as well, for example the imaging and analysis of soft tissue or biological samples.

Atomic force microscopy is a type of scanning probe microscopy that uses a sharp tip attached to a cantilever to scan the surface of a sample and measure the forces between the tip and the sample's surface atoms. The cantilever's motion is monitored and used to produce high-resolution images of the on-surface and sub-surface features and topography of the sample, with a resolution on the order of a few nanometers. Atomic force microscopy can be used in a variety of environments, including vacuum, air, and liquids, and can provide information on a wide range of sample properties, including mechanical, electrical, and magnetic properties.

Commonly, only predetermined sections of a sample are scanned in order to reduce scanning time. The predetermined sections may be picked for various reasons, e.g. a relatively high risk of manufacturing faults compared to other sections. A section is scanned by first inspecting and secondly by reviewing the sections. During inspection, the images and data that are generated by the atomic force microscope are analyzed to identify features and patterns on the sample surface and to determine the sample's properties. In this process, the results are evaluated to ensure that the data is accurate, consistent, and reliable. For example, this may involve verifying that the atomic force microscopy measurements were performed correctly. Verification is important to ensure the validity of atomic force microscopy results and to provide confidence in the information obtained from the atomic force microscopy measurement.

A disadvantage of atomic for microscopy is the relatively low scan speed compared to other imaging techniques. The scan speed is dependent on several factors, e.g. the size of the scan area, the resolution required and the cantilever oscillation frequency. For example, a large scan area with a high resolution may take several hours to scan, while a small area with lower resolution can be scanned in a matter of minutes. In recent years, there have been developments to improve the scan speed, such as parallel imaging techniques that use multiple cantilevers to scan the sample simultaneously, however the scan speed is still considered to be relatively slow.

The invention aims to counteract the above disadvantages, preferably while retaining the advantages. More specifically, the invention aims to reduce the overall scanning time a sample needs to be scanned before it is known if there are any defects on the sample.

Therefore, the invention provides for a method of inspecting and reviewing defects, in particular the method according to claim 1, using a scanning probe microscope comprising multiple scanning heads and a substrate carrier. Each of the multiple scanning heads comprises a probe including a probe tip arranged for scanning of a substrate surface. The method comprises:
providing the substrate on the substrate carrier, wherein the substrate carrier is arranged to position the substrate relative to at least one of the multiple scanning heads;
scanning of the substrate surface in a first scanning mode using at least one first scanning head of the multiple scanning heads;
scanning of the substrate surface in a second scanning mode using at least one second scanning head of the multiple scanning heads, wherein the at least one first scanning head and the at least one second scanning head are different scanning heads of the multiple scanning heads. The first scanning mode has a lower scanning resolution than the second scanning mode.

The scanning probe microscope can be an atomic force microscope; the substrate, or sample, comprises a broad scope of products e.g. polymers, nanoparticles such as nanotubes, biological samples and in particular semiconductors. The semiconductors, such as for example silicon wafers and GaAs, can be analyzed using the scanning probe microscope to detect defects. The substrates are provided on the substrate carrier, wherein the substrate carrier is able to move the substrate relative to the multiple scanning heads, e.g. a movable stage, a piezoelectric stage or a electromagnetic stage. Preferably, the movements provided by the substrate carrier is arranged to provide for precise movement, e.g. nanometer scale.

Multiple scanning heads are provided in order to facilitate the first and the second scanning mode, i.e. each scanning mode can have a dedicated scanning head. Additionally or alternatively, the multiple scanning heads are arranged to switch between the first and second operating mode, preferably when not scanning, such that the multiple scanning heads can be used in both modes to facilitating flexibility in configurations, which can speed up the inspecting and reviewing of defects in substrates.

In order to further facilitate the speed in which a substrate can be inspected and defects reviewed, the first scanning mode scans with a lower scanning resolution than the second scanning mode. In the context of the invention, resolution should be understood as the measure of ability of the scanning probe microscope to distinguish between different features, more specifically defects, on the surface of the substrate. Additionally, resolution should also be understood as to comprise lateral resolution, i.e. in a plane parallel to the surface of the substrate commonly denoted as the X-Y plane, and a vertical resolution, i.e. in the direction perpendicular to the plane of the substrate commonly denoted as the Z-direction. The resolution of the scanning probe microscope can be influenced by the shape and size of the probe tip, the stiffness of a cantilever provided in the scanning head that is arranged to hold the probe tip and the accuracy of the control system used to move the probe tip relative to the substrate surface or vice versa. In an example wherein the scanning probe microscope is used to scan a surface of the substrate in a scan direction, wherein the scan direction is a line in the plane parallel to the surface of the substrate, a measure of resolution may be the amount of lines scanned by the scanning probe microscope in the plane parallel to the surface of the substrate in a direction perpendicular to the scanning direction. Lowering the amount of scanned lines in the direction perpendicular to the scanning direction in the first scanning mode relative to the amount of scanned lines in the direction perpendicular to the scanning direction in the second scanning mode of the same surface results in a lower scanning resolution.

Advantageously, scanning in a lower scanning resolution may speed up the overall scanning process. In particular, the first scanning mode may be used for inspecting the substrate surface while the second scanning mode may be used to review possible defects found in by the first scanning mode. This way, the relatively high speed of the first scanning mode compared to the second scanning mode may be used to identify possible defects, while the slower but more accurate second scanning mode may be used to verify if the possible defects is indeed a defect and additionally may be used to clarify the type of defect. Using two different scanning modes, a low resolution and fast scanning mode and a high resolution slow scanning mode can be used to compliment each other, and mitigate each other's downsides, thereby increasing the overall speed of the scanning probe microscope while maintaining its accuracy.

In the first scanning mode the at least one first scanning head can move relative to a surrounding of the scanning probe microscope while the substrate remains stationary relative to the surrounding. The first scanning head can transverse relatively great distances while measuring compared to the second scanning mode, as the first scanning mode is scanning with a lower resolution. In order to facilitate relatively great distances and high speeds, it may be advantageously to actuate the first scanning head and keep the substrate stationary relative to the surrounding using the substrate carrier.

In the second scanning mode the at least one second scanning head can remain stationary relative to the surrounding while the substrate moves relative to the surrounding. In order to further facilitate a relatively high accuracy of the measurement performed by the second scanning head in the second scanning mode, the scanning head can be kept stationary while the substrate carrier moves the substrate relative to the second scanning head. Advantageously, the substrate carrier is arranged to perform accurate and relatively small movements compared to the movement performed by the scanning head in the first scanning mode. Alternatively, in the second scanning mode the probe of the at least one second scanning head can be moved relative to the surrounding of the scanning probe microscope, while both the substrate and the at least one second scanning head remain stationary relative to the surrounding. Even more accurate and smaller movement, further increasing the scanning resolution, may be achieved by just moving the probe tip of the second scanning head.

In a further advantageously embodiment, the scanning in the first scanning mode and scanning in the second scanning can be performed simultaneously. This may allow for the first scanning heads to scan relatively large areas quickly, while the second scanning heads are used to verify the results of the first scanning heads. Preferably, the multiple scanning heads are distributed in first scanning heads and second scanning heads in such a way that the first scanning heads and second scanning heads finish inspecting and reviewing defects respectively of a substrate substantially around the same time, thereby reducing the time spend scanning.

The probe tip of the at least one first scanning head of the multiple scanning heads can be of a first tip type and the probe tip of the at least one second scanning head of the multiple scanning heads can be of a second tip type, wherein the second tip type can be sharp compared to the first tip type. Relatively sharp tip types can be used for measurements requiring a relatively high resolution, e.g. in the second scanning mode.

While the sharp tip types may provide for a more accurate measurement, they are also more vulnerable to defects or breaking. In order to increase reliability, especially of the first scanning head, a relatively blunt tip type can be used for the first scanning heads. The relatively low resolution may be considered less of a challenge in the first scanning mode, as this scanning mode operates at a relatively low resolution compared to the second scanning mode, such that a relatively blunt tip does not limit the scanning resolution.

In the first scanning mode the surface of the substrate can be scanned parallel to a first direction in a plane parallel to the surface of the substrate. The second scanning mode surface of the substrate can be scanned parallel to a second direction in a plane parallel to the surface of the substrate, wherein the first direction can be perpendicular to the second direction. In a particular advantageously embodiment, the first scanning mode can be used to scan in a first direction, preferably a direction parallel to the deposited material on the substrate. By letting the relatively low resolution of the first scanning mode follow the deposited material on the substrate, the resolution of the first scanning mode can be lowered further without reducing the chance of missing defects during the inspection stage significantly. When reviewing a possible defect in the second stage, the second scanning mode may be used having a scan direction perpendicular to the deposited material on the substrate and the scan direction of the first scanning head, increasing accuracy.

Furthermore, the invention provides for a scanning probe microscope for inspecting and reviewing defects in substrates, comprising multiple scanning heads, wherein each scanning head comprises a probe including a probe tip arranged for scanning of a substrate surface. The scanning probe microscope furthermore provides for a substrate carrier arranged to position a substrate relative to at least one of the multiple scanning heads. The multiple scanning heads comprise at least one first scanning head. The probe tip of the first scanning head is of a first tip type. The multiple scanning heads comprise at least one second scanning head. The probe tip of the first scanning head is of a second tip type. The probe tip of the second tip type is more sharp than the probe tip of the first tip type. The scanning probe microscope is arranged to scan the surface of a substrate using the at least one first scanning head and the at least one second scanning head simultaneously during use.

The first scanning heads can be arranged to scan a substrate surface parallel to a first direction in a plane parallel to a surface of the substrate carrier. The second scanning heads can be arranged to scan a substrate surface parallel to a second direction in the plane parallel to the surface of the substrate carrier. The first direction can be perpendicular to the second direction.

The scanning probe microscope can further comprise moving means for moving, in the first scanning mode, the at least one first scanning head relative to a surrounding of the scanning probe microscope, while maintaining the substrate carrier stationary relative to the surrounding.

In addition, the scanning probe microscope can further comprise moving means for moving, in the second scanning mode, the substrate carrier relative to a surrounding of the scanning probe microscope, while maintaining the at least one second scanning head stationary relative to the surrounding.

The at least one second scanning head further comprises moving means for moving, in the second scanning mode, the probe tip relative to a surrounding of the scanning probe microscope, while maintaining the substrate carrier stationary relative to the surrounding.

In addition, the invention provides for a computer program product comprising instructions which, when loaded into a memory of a scanning probe microscope described above, enable a controller of the scanning probe microscope to perform the method described previously.

Further advantageous aspects of the invention are set out in the description and appended claims.

The technical features described in the paragraphs and sentences above can be isolated from the context, and the isolated technical features from the different paragraphs and sentences can be combined. Such combinations are herewith specifically disclosed in this description.

The invention will further be elucidated on the basis of exemplary embodiments which are represented in the drawings. The exemplary embodiments are given by way of non-limitative illustration of the invention.

In the drawings:

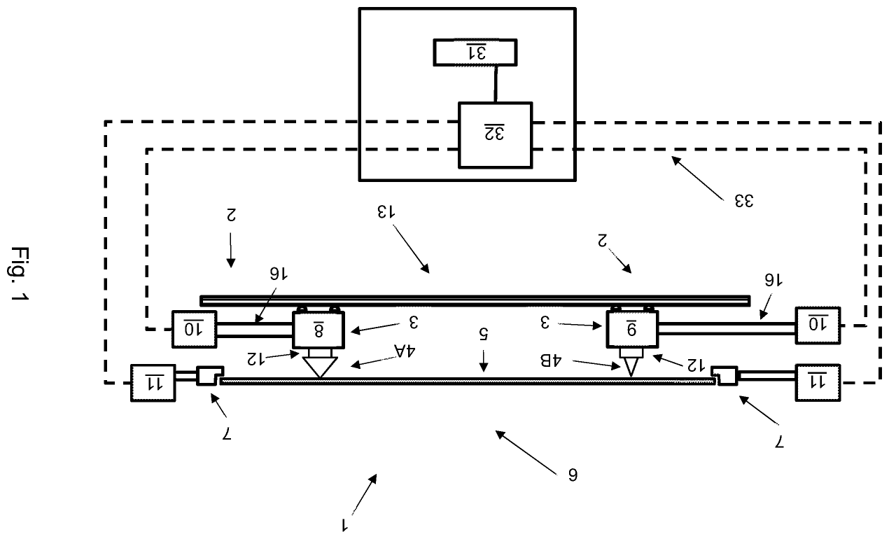

FIG. 1 shows a schematic side view of a scanning probe microscope according to an embodiment invention;

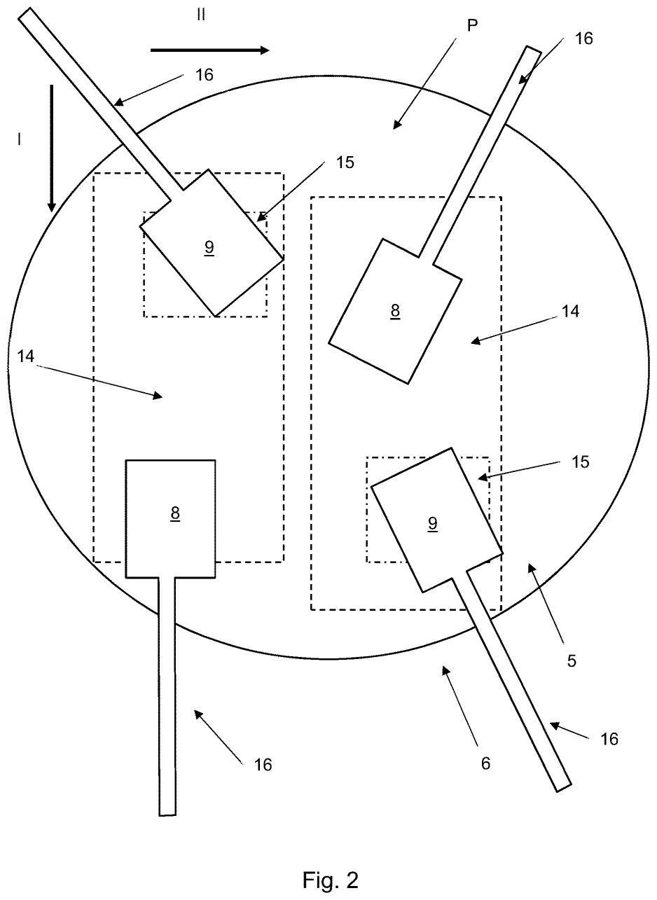

FIG. 2 shows a schematic top view of a substrate that is scanned according to an embodiment of the invention;

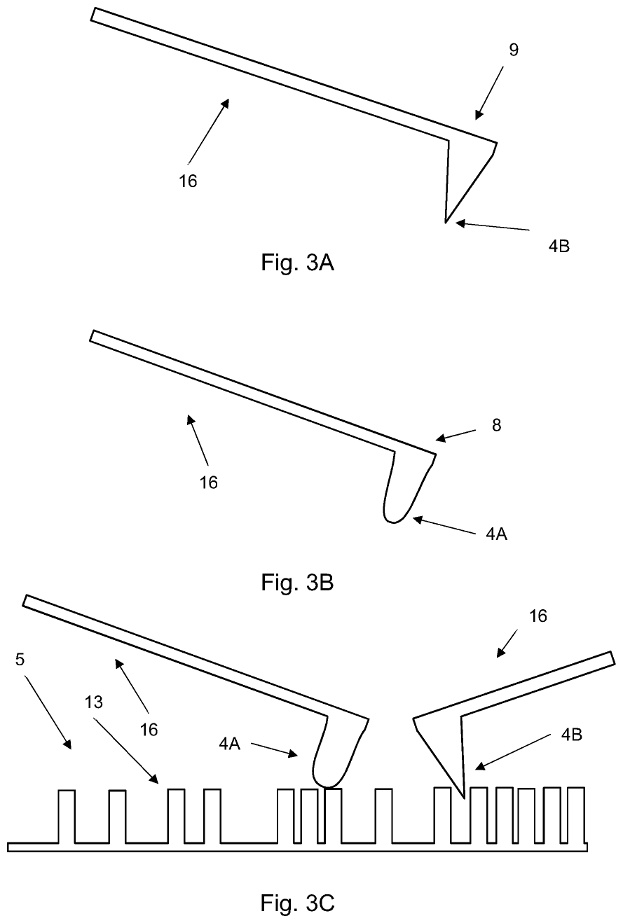

FIG. 3A shows a schematic side view of a second scanning head;

FIG. 3B shows a schematic side view of a first scanning head;

FIG. 3C shows a schematic side view of a substrate that is being scanned by the scanning heads of FIGS. 3A and 3B;

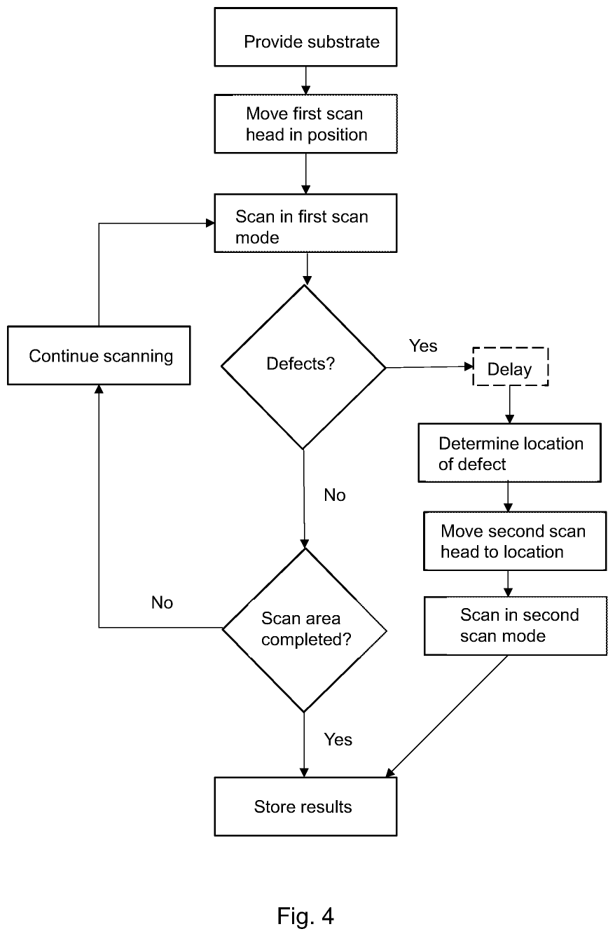

FIG. 4 depicts a flowchart of the method for detecting and reviewing defects in a substrate.

It is noted that the figures are only schematic representations that are given by way of non-limited examples. In the figures, the same or corresponding parts are designated with the same reference numerals.

Turning to FIG. 1, a scanning probe microscope 1, preferably the scanning probe microscope according to claim 1, is depicted. The scanning probe microscope 1 comprises multiple scanning heads 2. In the shown example two scanning heads 2 are presented, however it will be understood by the person skilled in the art that any number of scanning heads 2 can be used. Each scanning head 2 comprises a probe 3 that includes a probe tip 4 arranged for scanning a surface 5 of a substrate 6. The scanning probe microscope 1 further comprises a substrate carrier 7 arranged to support and position the substrate 6 relative to at least one of the multiple scanning heads 2. The substrate carrier 7 in the shown embodiment is an X-Y stage, arranged to move the substrate 6 in a plane parallel to the surface 5.

The multiple scanning heads 2 comprise at least one first scanning head 8, wherein the probe tip 4 is of a first tip type 4A. The multiple scanning heads 2 further comprise at least one second type scanning head 9 wherein the probe tip 4 of the second scanning head 9 is of a second tip type 4B. The probe tip of the second tip type 4B is more sharp than the probe tip of the first tip type 4A.

In order to facilitate movement of the first scanning head 8, in a first scanning mode, relative to a surrounding of the scanning probe microscope 1 while maintaining the substrate carrier 7 stationary relative to the surrounding, moving means 10 are provided. In the shown embodiment, moving means 10 is an actuator arranged to move the first scanning head 8 via an arm 16 The scanning probe microscope 1 further comprises moving means 11 for moving, in a second scanning mode, the substrate carrier 7 relative to the surrounding while maintaining the at least one second scanning head 9 stationary relative to the surrounding via an actuator 11. Additionally, the at least one second scanning head further comprises moving means 12, in the shown example a piezo-electric element, for moving the probe tip 4B relative to the surrounding while maintaining the substrate carrier 7 stationary relative to the surrounding in the second scanning mode. The scanning probe microscope 1 is arranged to scan the surface 5 of the substrate 6 using at least one first scanning head 8 and the at least one second scanning head 9 simultaneously during use. In the shown embodiment, this may be done by having the second scanning mode, i.e. the high resolution scanning mode with a relative small movement provided by the X-Y stage 7 via actuator 11, prescribe a movement first while the first scanning mode, i.e. the low resolution scanning mode with a relatively large movement provided by actuating the at least one second scanning head 9 via an arm 16. The movement of the at least one second scanning head 9 accounts for the relatively small movement of the X-Y stage 7 via a controller 32.

Referring to FIG. 2, a schematic of a top view of an example of the surface 5 of a substrate 6 is depicted. On the surface 5 lines of material have been deposited. As an example, two inspection areas 14 have been predetermined to be scanned. The first scanning heads 8 are arranged to scan the inspection areas 14 on the substrate surface 5 parallel to a first direction I in a plane P parallel to the substrate surface 5. When the first scanning heads 8 detects an anomaly, i.e. a gap or bridge, the possible location of such an anomaly is called a review area 15. Such a review area 15 can be scanned by the second scanning head 9 to more accurately scan and verify if there is indeed a gap or bridge. It will be clear to the person skilled in the art that the review area 15 is a small area compared to the inspection area 14, as the review area 15 only comprises the possible defect and the direct surrounding of the possible defect. The review area 15 in FIG. 2 has been depicted relatively large for illustrative purposes. The second scanning head 9 is arranged to scan the substrate surface 5 parallel to a second direction II in the plane P parallel to the surface 5. The first direction I is perpendicular to the second direction II.

The scanning probe microscope 1 further comprises a computer program product comprising instructions which, when loaded into a memory 31 of the scanning probe microscope 1, enables a controller 32 of the scanning probe to control the moving means 10, 11, 12. Preferably, the controller 32 actuates the moving means 10, 11, 12 such that the total time scanning a substrate is minimized. In the shown embodiment this means that the at least one scanning head 2 operating in a first scanning mode scans the bulk of the surface 5 of the substrate 6 while the at least one scanning head 2 operating in the second scanning mode scans possible defects found by the scanning head 2 operating in the first scanning mode. Preferably, the scanning head 2 operating in the second scanning mode and the scanning head 2 operating in the first scanning mode finish scanning relatively close to each other, more preferably at the same time. The controller 32 is connected via information carrying cables 33 to the various moving means 10, 11, 12.

In a special example, the first direction I is parallel to the deposited lines, such that the tip 4 of the first scanning head 8 is provided on and follows the deposited line 13. In an particular advantageous example, the first scanning head 8 only scans where deposited lines are expected, following the pattern of the expected deposited lines. By only scanning by following the pattern of expected deposited lines in the first scanning mode, the amount of scanning time of the first scanning head 8 can be minimized.

Turning to FIGS. 3A, 3B, schematic side views of the first and second scanning head 8, 9 are depicted. In the shown examples, the difference in tip types of the first and second scanning 8, 9 is further emphasized. The tip 4B of the second scanning head 9 is relatively sharp compared to the tip 4A of the fist scanning head 8, e.g. the end of the tip 4A of the first scanning head 8 is more convexly shaped. Turning to FIG. 3C, depicted the surface 5 of a substrate on which material 13 has been deposited, the effect of the tip types is seen. The relatively sharp tip 4B can fit in to smaller gaps between the lines of deposited material 13. The relatively blunt tip 4A of the first scanning head 8 is more robustly shaped and can therefore be moved faster over the surface 5 of the substrate.

Moving the relatively sharp tip 4B of the second scanning head 9 at a comparable speed might result in damaging of the tip, as it may be more fragile and may get more easily lodged between the lines of deposited material 13.

FIG. 4 depicts a flow chart of an example of method of inspecting and reviewing defects in substrates according to the invention. First, a substrate is provided, and preferably predetermined areas for scanning are identified. The first scanner head 8 is moved in to position, i.e. to the location of the predetermined area that needs to be scanned. The first scanner head 8 is scanning in a first scan mode. If no possible defects are found the first scanner head 8 will keep scanning in the first scanning mode until the scan area is completed, after which the results will be stored. If a possible defect is found, the second scanner head 9 can be used in a second scanning mode to verify the result. Optionally, second scanning mode is delayed, if the first scanner head 8 makes it physically impossible to reach the location of the possible defect, e.g. when the first scanner head 8 is still scanning nearby. The location of the defect is determined, e.g. the X and Y coordinates on the substrate, after which the second scanner head is moved to the location to start scanning. Once the area of the possible defect has been scanned by the second scanner head 9, the results are stored.

Many variations will be apparent to the skilled person in the art. For example, it will be clear to the skilled person that while only two scanning heads 2 are depicted, any amount of scanning heads 2 may be used. In addition, in the shown example there is an equal amount of first scanner heads 8 and second scanner heads 9, while it is understood that this not necessary and in the scanning probe microscope may use any number of first and second scanner heads. Furthermore, while in the shown examples the deposited materials on the substrate are in straight lines, any shape of deposited material may be used. Such variations are understood to be comprised within the scope of the invention as defined in the appended claims.

1: A method of inspecting and reviewing defects in substrates using a scanning probe microscope comprising multiple scanning heads and a substrate carrier,
wherein each of the multiple scanning heads comprises a probe including a probe tip arranged for scanning of a substrate surface,
wherein the method comprises:
providing the substrate on the substrate carrier, wherein the substrate carrier is arranged to position the substrate relative to at least one of the multiple scanning heads;
scanning of the substrate surface in a first scanning mode using at least one first scanning head of the multiple scanning heads;
scanning of the substrate surface in a second scanning mode using at least one second scanning head of the multiple scanning heads, wherein the at least one first scanning head and the at least one second scanning head are different scanning heads of the multiple scanning heads;
wherein the first scanning mode has a lower scanning resolution than the second scanning mode;
wherein in the first scanning mode the surface of the substrate is scanned parallel to a first direction in a plane parallel to the surface of the substrate, wherein in the second scanning mode the surface of the substrate is scanned parallel to a second direction in the plane parallel to the surface of the substrate, wherein the first direction is perpendicular to the second direction; and
wherein scanning in the first scanning mode and scanning in the second scanning are performed simultaneously.

2: The method of inspecting and reviewing defects according to claim 1, wherein in the first scanning mode the at least one first scanning head move relative to a surrounding of the scanning probe microscope while the substrate remains stationary relative to the surrounding.

3: The method of inspecting and reviewing defects according to claim 1, wherein in the second scanning mode the at least one second scanning head remains stationary relative to the surrounding while the substrate moves relative to the surrounding; or
wherein in the second scanning mode the probe of the at least one second scanning head is moved relative to the surrounding of the scanning probe microscope, while both the substrate and the at least one second scanning head remain stationary relative to the surrounding.

4: The method of inspecting and reviewing defects according to claim 1, wherein the probe tip of the at least one first scanning head of the multiple scanning heads is of a first tip type and wherein the probe tip of the at least one second scanning head of the multiple scanning heads is of a second tip type, wherein the second tip type is sharp compared to the first tip type.

5: The method of inspecting and reviewing defects according to claim 1, wherein the first scanning mode is used to identify potential defects and wherein the second scanning mode is subsequently used to verify if the potential defects are defects.

6: The method of inspecting and reviewing defects according to claim 1, wherein scanning in the first scanning mode comprises inspecting the substrate and wherein scanning in the second scanning mode comprises reviewing defects found during the first scanning mode.

7: A scanning probe microscope for inspecting and reviewing defects in substrates, comprising:
multiple scanning heads, wherein each scanning head comprises a probe including a probe tip arranged for scanning of a substrate surface;
a substrate carrier arranged to position a substrate relative to at least one of the multiple scanning heads;
wherein the multiple scanning heads comprise at least one first scanning head, wherein the probe tip of the first scanning head is of a first tip type, and wherein the multiple scanning heads comprise at least one second scanning head, wherein the probe tip of the second scanning head is of a second tip type;
wherein the probe tip of the second tip type is more sharp than the probe tip of the first tip type; and
wherein the scanning probe microscope is arranged to scan the surface of a substrate using the at least one first scanning head and the at least one second scanning head simultaneously during use; and
wherein the first scanning heads are arranged to scan a substrate surface parallel to a first direction in a plane parallel to a surface of the substrate carrier and wherein the second scanning heads are arranged to scan a substrate surface parallel to a second direction in the plane parallel to the surface of the substrate carrier, and wherein the first direction is perpendicular to the second direction.

8: The scanning probe microscope according to claim 7, further comprising moving means for moving, in a first scanning mode, the at least one first scanning head relative to a surrounding of the scanning probe microscope, while maintaining the substrate carrier stationary relative to the surrounding.

9: The scanning probe microscope according to claim 7, further comprising moving means for moving, in a second scanning mode, the substrate carrier relative to a surrounding of the scanning probe microscope, while maintaining the at least one second scanning head stationary relative to the surrounding.

10: The scanning probe microscope according to claim 7, wherein the at least one second scanning head further comprises moving means for moving, in the second scanning mode, the probe tip relative to a surrounding of the scanning probe microscope, while maintaining the substrate carrier stationary relative to the surrounding.

11: A non-transitory computer readable medium comprising instructions which, when executed by a processor of a scanning probe microscope, cause a controller of the scanning probe microscope to perform a method according to claim 1.
